(19) United States
(12) Patent Application Publication
(10) Pub. No.: US 2023/0369697 A1
(43) Pub. Date: Nov. 16, 2023

(54) COMPOSITE BATTERY TRAY STRUCTURE

(71) Applicant: TPI Composites, Inc., Warren, RI (US)

(72) Inventors: Paul Roehm, Wyoming, MI (US); McKevin Veloso, Lincoln, RI (US); John Perraut, Somerset, MA (US)

(21) Appl. No.: 18/316,845

(22) Filed: May 12, 2023

Related U.S. Application Data
(60) Provisional application No. 63/341,465, filed on May 13, 2022.
(60) Provisional application No. 63/341,512, filed on May 13, 2022.
(60) Provisional application No. 63/341,519, filed on May 13, 2022.
(60) Provisional application No. 63/341,523, filed on May 13, 2022.

(51) Int. Cl. H01M 50/229; H01M 50/249; H01M 50/271; H01M 50/262; H01M 50/242; B29C 70/52

(52) U.S. Cl. CPC H01M 50/229; H01M 50/249; H01M 50/271; H01M 50/262; H01M 50/242; B29C 70/523; B29C 70/526; B29L 2031/3468

(57) ABSTRACT

A system for a composite battery tray structure, the system including a floor extending in a longitudinal and transverse direction, the floor configured to receive at least one battery, at least one cross member disposed on the floor and extending in the transverse direction, the at least one cross member having a top surface, bottom surface and sidewalls extending vertically therbetween, the at least one cross member having a first flange extending vertically upward from the top surface, the at least one cross member having a second flange extending laterally from the bottom surface, the at least one cross member being hollow, with a support rib extending between the sidewalls and a lid disposed above the cross member, the lid having a channel extending upward, the channel configured to receive the first flange of the at least one cross member.

### CROSS REFERENCE TO RELATED APPLICATIONS

This application claims priority from US Provisional Application Nos. 63/341,465, titled “COMPOSITE BATTERY TRAY STRUCTURE” filed on May 13, 2022, 63/341,512, titled “SYSTEM AND METHOD FOR FIBER METAL LAMINATE FOR VEHICLE APPLICATIONS” filed on May 13, 2022, 63/341,519, “SYSTEM AND METHOD FOR INTEGRATED END CAPS FOR PULTRUSION” filed on May 13, 2022, and 63/341,523, titled ‘SYSTEM AND METHOD FOR MULTI RESIN PULTRUSION” filed on May 13, 2022, the entire contents of which are hereby incorporated by reference.

### BACKGROUND OF THE DISCLOSED SUBJECT MATTER

### Field of the Disclosed Subject Matter

The disclosed subject matter relates to a system for a composite battery structure and components thereof. Particularly, the present disclosed subject matter is directed to a composite structural frame of a battery tray configured for use in an electric vehicle, cooling of the battery tray and sealing of same.

### DESCRIPTION OF RELATED ART

Typically, securing batteries in a vehicle include use of metallic trays, which are heavier than composite trays. Energy efficiency increases when a vehicle is lighter, so a need arises for lightening of vehicles by material selection and manufacturing techniques. However, conventional composite tray concepts do not capitalize on efficient joining methods and embedded features that add functionality to high volume composite processes.

There thus remains a need for an efficient and economic method and system for creating lightweight, sealed, composite battery compartments having minimalized volume for use in an electric vehicle.

One method for forming vehicle bodies includes using composites and/or thermoset composites. Thermoset composites have difficulty joining in metal-dominated vehicle bodies, and have unstable failure modes—which raises concern in impact-driven components. Current fiber metal laminates are expensive to create and do not prevent interlaminar shear. Current metallic components are heavier than the proposed fiber-metal-laminate. Furthermore, current composite components are cost-inefficient for creating isotropic properties and for failure predictability

There thus remains a need for an efficient and economic method and system for coupling metal and composites, such as those from fiber (e.g. carbon, glass, aramid, etc.) into an assembly suitable for use with electric vehicles. This system fulfills a need to mitigate failure mechanisms in lightweight composites, create an easier assembly aid during processing, and provide multi-material functionality in a single part.

Conventional methods for putting an end cap on a process component are usually added after processing of the initial component—adding time and money to the operation, as well as the added complexity of a discrete process required to manufacture the end cap itself.

There thus remains a need for an efficient and economic method and system for forming an integrated end cap in pultrusion operation, as described herein.

Conventional methods for pultruding components with resin are time and cost intensive as they need to be repeated for every component, and for every side that requires a function associated with a different resin or other factor associated with resin (e.g. temperature, time, etc.). Additive solutions typically decrease mechanical/structural properties and may not be able to meet the full requirements of the part without significant drawbacks (e.g. elongation, fracture toughness, etc.). Also, fiber solutions (e.g. veils and fabrics) typically are niche and cost prohibitive. These techniques also may come at the expense of package space that could be used by other fibers (e.g. glass replaced by polyester) and any secondary solutions (e.g. coatings) are typically a separate/dedicated secondary process, which is exacerbates costs.

There thus remains a need for an efficient and economic method and system for multi resin pultrusion as described herein.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a system for a composite battery tray structure, the system including a floor extending in a longitudinal and transverse direction, the floor configured to receive at least one battery, at least one cross member disposed on the floor and extending in the transverse direction, the at least one cross member having a top surface, bottom surface and sidewalls extending vertically therbetween, the at least one cross member having a first flange extending vertically upward from the top surface, the at least one cross member having a second flange extending laterally from the bottom surface, the at least one cross member being hollow, with a support rib extending between the sidewalls and a lid disposed above the cross member, the lid having a channel extending upward, the channel configured to receive the first flange of the at least one cross member.

In some embodiments, the second flange is configured to engage at least a portion of the floor.

In some embodiments, the at least one cross member creates a seal with the floor via a gasket disposed therebetween.

In some embodiments, the at least one cross member creates a seal with the lid via a gasket disposed therebetween.

In some embodiments, the at least one cross member includes a core component disposed therein.

In some embodiments, the at least one cross member has at least one pin disposed therein, the at least one pin extending laterally within the at least one cross member.

In some embodiments, the at least one pin extends from a first side wall to a second sidewall within the cross member.

In some embodiments, the at least one pin extends from a first side wall at a non-normal angle therefrom.

In some embodiments, the at least one pin has a first cylindrical portion having a first diameter, and a second cylindrical portion having a second diameter, the first diameter being larger than the second diameter, the first cylindrical portion abutting a first side wall of the cross member.

To achieve these and other advantages and in accordance with the purpose of the disclosed subject matter, as embodied and broadly described, the disclosed subject matter includes a method of forming integrated end caps, the method including providing a first core component, the first core component comprises a first end and a second end, positioning the first core component between a first end cap component and a second end cap component, the first and second end cap components having substantially the same cross-sectional thickness as the first core component, providing a second core component, the second core component having a first end and a second end, positioning the second core component between a third end cap component and a fourth end cap component, the third and fourth end cap components having substantially the same cross-sectional thickness as the second core component, pultruding the core components with the end cap components to form a pultruded assembly, the first end cap component disposed at a first end of the core component, and the second end cap component disposed at the second end of the core component and cutting the pultruded assembly at a point along the second end cap component.

In some embodiments, cutting the pultrusion comprises cutting the pultrusion at a non-normal angle.

In some embodiments, at least one end cap component is made of a metal, thermoset, or thermoplastic.

In some embodiments, at least one end cap component comprises one or more connection terminals.

To achieve these and other advantages and in accordance with the purpose of the disclosed subject matter, as embodied and broadly described, the disclosed subject matter includes system for multi resin pultrusion, the system including a first material disposed on a first spool and configured to be pulled from one end, a first resin receptacle disposed downline from the first material comprising at least an opening and configured to allow the first material to be pulled at least partially through a first resin disposed therein, a second material disposed on a second spool and configured to be pulled from one end parallel to and in the same direction as the first material, a second resin receptacle disposed downline from the second material comprising at least an opening and configured to allow the second material to be pulled at least partially through a second resin disposed therein, an isolator material disposed on a third spool disposed in between the first material and the second material and configured to be pulled parallel to and in the same direction as the first material and the second material, the isolator disposed between the first and second material and at least one die disposed downline from the first material, the second material, and the isolator material configured to impart a cross sectional shape to the first material, the second material and the isolator material therebetween as they are pulled through the die.

In some embodiments, the at least one die comprises a first cavity and a second cavity separated therebetween by a wall, the first resin is configured to be injected into the first cavity and pulled through the die as a solid, the second resin is configured to be injected into the second cavity and pulled through the die as a solid, and wherein the solid formed by the first resin and the solid formed by the second resin are pulled through the die to form a hybrid resin pultrusion, wherein the hybrid resin pultrusion is the coupled first resin and second resin.

In some embodiments, a first die is disposed downline from the first material configured to impart a cross sectional shape to the first material and a second die disposed downline from the second resin configured to impart a cross sectional shape to the first and the second material.

In some embodiments the first die comprises a first mandrel configured to force the first resin into a first area and a blocking mandrel configured to prevent the first resin to enter a second area and the second die comprises the blocking mandrel which has tapered down to a smaller cross sectional area, therefore allowing the second resin to enter a second area and the first resin has since cured therefore preventing the second resin to enter the first area.

In some embodiments, the first die and the second die are configured to impart a common cross sectional shape.

In some embodiments, the first die is configured to impart a first cross section shape and the second die is configured to impart a second cross sectional shape.

In some embodiments, the first and second material exit the second die to form an integral component.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a schematic representation of a composite battery tray structure in accordance with the disclosed subject matter.

FIG. 2 is a schematic representation of a sealing structure of a composite frame or cross members in accordance with the disclosed subject matter.

FIGS. 3A and 3B are schematic representations of a sealing structure of a composite frame utilizing support structures in an embodiment.

FIGS. 4A-4C are schematic representations of a frame structure including node with crush initiators and off-axis support for a cross beam, in an embodiment.

FIGS. 5A-5C are schematic representations of a various embodiments of a frame structure.

FIGS. 6A-6C is a schematic representation of cross members of a frame structure including lid sealability features and robust connection features.

FIG. 7 is a schematic representation of cross members of a frame structure including sealability features and cutouts for cross member connection.

FIG. 8 is a flow chart depicting an exemplary method for integrated end caps in a pultrusion process.

FIG. 9 is a schematic representation of the method for embedded end caps in pultrusion in accordance with the disclosed subject matter.

FIG. 10 is a schematic representation of the method for embedded end caps in pultrusion in accordance with the disclosed subject matter.

FIG. 11 is a schematic representation of the method for embedded end caps in pultrusion in accordance with the disclosed subject matter.

FIGS. 12A-12B is a schematic representation of the various systems for multi resin pultrusion in accordance with the disclosed subject matter.

FIG. 13 is a cross sectional representation of a die with two cavities for injection of two resins in accordance with the disclosed subject matter.

FIG. 14 is a cross sectional representation of two die with a plurality of mandrels with tapered sizes and varying locations to change the pultrusion shape as it's pulled through respective dies, according to embodiments.

FIG. 15 is a schematic representation of the various embodiments of fiber metal composites in accordance with the disclosed subject matter.

### DETAILED DESCRIPTION OF AN EXEMPLARY EMBODIMENT

Reference will now be made in detail to exemplary embodiments of the disclosed subject matter, an example of which is illustrated in the accompanying drawings. The method and corresponding steps of the disclosed subject matter will be described in conjunction with the detailed description of the system.

### Composite Battery Tray

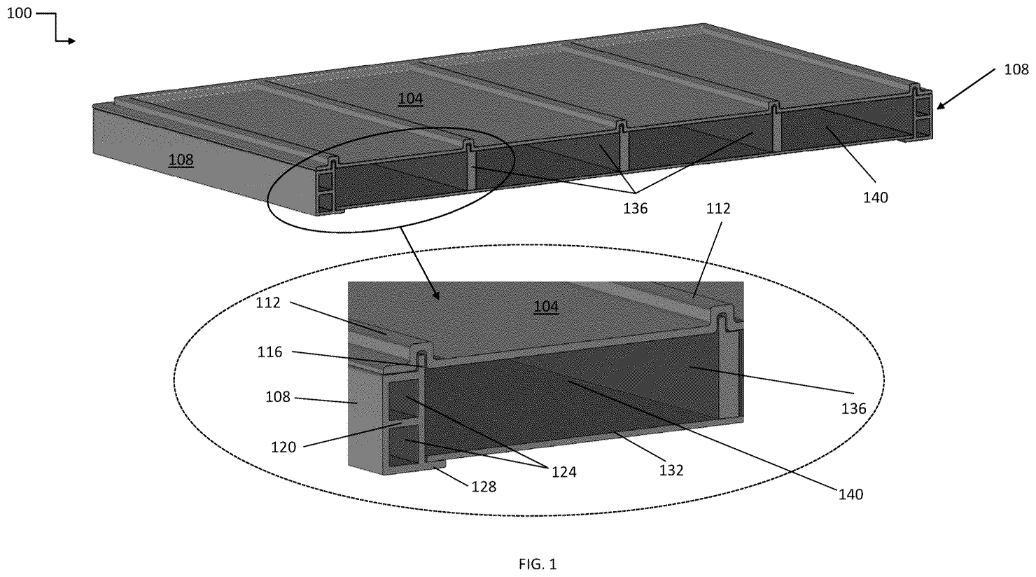

Referring now to FIG. 1, a battery tray 100 a schematic representation of a sealing structure of a composite battery tray structure with a frame and cross members shown in cross-sectional isometric and detail views. Battery Tray 100 includes a lid 104 configured to span the planform area of the battery tray 100 with a plurality of cross members 108 extending from a first side of battery tray 100 to a second side of battery tray 100. Additionally, secondary cross members 136 can be disposed between the primary cross members 108 (e.g. equidistantly spaced from each other, or with non-uniform configuration).

One of ordinary skill in the art would appreciate that lid 104 may alternatively be referred to as “cover,” “cover member,” “cover component,” “lid component,” “lid member” or the like. Lid 104 may have one or more corresponding geometric features (e.g. protrusions, indents, channels, etc.) configured to at least partially engage with a cross member 108, including a channel 112. In various embodiments, lid 104 may have a generally planar shape. In various embodiments, lid 104 may have a generally rectangular or square planform shape. In various embodiments, lid 104 may have a planform shape corresponding to a larger negative space in an assembly, such as to accommodate components not described in this application, such as wheel well, ducting or the like. Battery Tray 100 and any components described thereof or therewith may include features as described in U.S. Pat. No. 10,431,789, the entire contents of which are hereby incorporated by reference.

Lid 104 may have one or more channels 112 configured to partially engage a flange 116 of cross member 108. Flange 116 can extend vertically upward to be matingly received by the lid channel 112, as shown. Also, flange 116 can be located at the interior side of the cross member 108 (i.e. on the side furthest from the vehicle wheel location), such that it is spaced from the longitudinal edge of the cross member 108. Thus, in some embodiments the cross member 108 is asymmetric. Lid 104 may be any lid as described herein. Channel 112 may span the width of lid 104 or a portion thereof. Channel 112 may be configured to locate and align cross member 108 relative to lid 104. Channel 112 may be configured to locate and retain cross member 108 and lid 104 relative to each other, constraining relative motion of the components. Channel 112 may span a fraction of the width of lid 104, such as halfway across, or in periodic instances, such as three partial channels configured to engage a matching flange 116 arrangement on cross member 108. Lid 104 may have any number of channels 112 having the same configuration, for example, each channel 112 spanning the entire width of lid 104. In various embodiments, lid 104 may have a plurality of channels 112 each having a distinct configuration, and or depth/recess, such as a first channel 112 spanning the whole width of lid 104 and a second channel 112 having two equidistant slots. In this non-limiting example, the channels 112 may be configured to assist in the assembly of battery tray 100, creating an assembly that has only one correct possible arrangement of components. In various embodiments, cross member 108 may have a generally horizontal upper section configured to engage a generally planar portion of lid 104, this horizontal upper section may be the end of cross member 108 and provide support for the weight of lid 104.

Lid 104 may shield emission of Electro-Magnetic Frequencies (EMF) over a range of frequencies, e.g. 1 kHz to 1 GHz, while providing electrical continuity through attached surfaces designed for EMF containment and electrical grounding. The EMF shielding can be incorporated in a variety of ways, e.g., EMF shielding can be provided throughout the lid 400 in the form of a metal-filled paint, conductive ink, or as a metal foil or wire mesh embedded or woven into the laminate. In such embodiments, the current moves between the tray, the lid and the chassis of the vehicle via bolts and screws. Additionally, or alternatively, metal rods, chains or nails can be employed as an electrical transmission method. For example, features can be designated to conduct electrical currents across the lid. In some embodiments the lid 104 can incorporate reinforcements including carbon, fiberglass, aramid, spectra, basalt, metallic wire and/or combinations thereof which enhance the structural integrity of the lid/lid. In some embodiments the lid 104 can incorporate matrix materials including: Phenolic, Epoxy, Polyester, Vinylester and/or combinations thereof. An aspect of the lid (or lid) may include features as described in U.S. Pat. No. 11,084,386, the entire contents of which are hereby incorporated by reference.

With continued reference to FIG. 1, cross member 108 may have flange 116 extending in a vertical direction into channel 112. Flange 116 may have a complimentary shape to channel 112. For example and without limitation, flange 116 may have a rectangular cross section corresponding to the interior shape of channel 112. In various embodiments, the flange 116 may be generally bull nosed and channel 112 may be correspondingly shaped. In various embodiments, flange 116 may be planar in shape. In various embodiments, flange 116 may be disposed at an angle to the vertical axis, configured to engage channel 112 with a corresponding interior disposed at the same angle. In various embodiments, flange 116 may be disposed at an angle between 0 degrees (vertical) to 45 degrees in either direction.

The lid 104, and/or a base member, can be formed from a variety of manufacturing techniques. For example, a liquid compression molding (LCM) process can be employed to fabricate the lid and base members. Additionally, resin may be robotically layered on top of the part prior to entering press vs injecting with resin into tool with High Pressure Resin Transfer Molding (HP-RTM). In some instances, the LCM technique can provide advantages (vs HP-RTM) including: faster cycle time since resin is applied outside the mold; less complicated tooling; no preforming required and thus less waste. Furthermore, to facilitate the containment of adverse events (e.g. overheating, fire, etc.) within a given cell, the lid 104 and/or floor 132, cross member 108 or any other component can be formed from materials which exhibit a heat resistance of 600° C. for a period of an hour without compromising the structural integrity of the member (e.g. no warping, thinning, formation of holes, etc.).

In various embodiments, cross member 108 is generally hollow, with at least one support rib 120 internally disposed therein. In various embodiments, support rib 120 may be located at the vertical midpoint of cross member 108, spanning from interior sidewall to exterior sidewall. In various embodiments, support rib 120 may be disposed at a quarter of the way up the vertical walls of cross member 108, affixed to both vertical walls at a right angle. In various embodiments, support rib 120 may be disposed within cross member 108 at any point along the vertical walls, spanning from wall to wall horizontally. In various embodiments, support rib 120 may extend within the cross member 108 at an angle, for example sloping upwardly or downwardly, from the outside wall of cross member 108 to the inside wall of cross member 108. In various embodiments, there may be more than one support rib 120 disposed within any one cross member 108, such as two support rib 120, thus creating three hollows 128 within cross member 108. In various embodiments, there may be more than one support rib 120 within cross member 108, each support rib 120 may be affixed to another support rib 120, such as to create an ‘X’ cross section shape. In various embodiments, a first support rib 120 may extend horizontally within cross member 108, and a second support rib 120 may be affixed to the first support rib 120, and extend to one of the vertical walls of cross member 108 at an angle. In various embodiments a first support rib 120 may extend horizontally within cross member 108, a second and third support rib 120 may be affixed at the center of the first support rib 120, and each extend to the vertical walls of cross member 108, thereby forming a ‘K’ shaped support wall structure within cross member 108.

With continued reference to FIG. 1, cross member 108 may include at least one hollow portion 124. There may be one hollow 124 disposed at the center of cross member 108. In various embodiments, there may be two hollows symmetrically spaced and disposed within cross member 108. In various embodiments, at least a portion of cross member 108 span, such as in the center of cross member 108's long axis, or periodically spaced there through. In various embodiments, there may be any number of equally spaced rectangular hollows 124 spanning the cross member 108. For example and without limitation, there may be six hollows, spaced in two rows of three hollows in the cross section of the cross member 108 and spanning the length of cross member 108. In various embodiments, cross member 108 may include more than one hollow 124, each hollow having a varying length into cross member 108, for example and without limitation, a first hollow 124 may extend a first distance into cross member 108, and a second hollow 124 may extend a second distance into cross member 108, the first distance different than the second distance. In various embodiments, cross member 108 may have two hollows, each extending from opposite ends of cross member 108 extending towards a middle portion of cross member 108. In this non-limiting example, cross member 108 may have a wall separating the cross member 108's two hollows 124.

With continued reference to FIG. 1, cross member 108 may have a floor flange 128 configured to engage with a floor 132. Floor flange 128 may extend horizontally from a second end of cross member 108, the second end disposed at the opposite end of the first end of cross member 108 that is affixed to flange 116. Thus floor flange 128 can be configured with a perpendicular orientation to the flange 116—both of which can extend from the interior sidewall (i.e. sidewall spaced furthers from wheel location) of the cross member 108. In various embodiments, floor flange 128 may be configured to engage the underside of floor 132. In various embodiments, floor flange 128 may be configured to engage the upper side of floor 132. In various embodiments, floor flange 128 may be configured to abut and engage a lateral edge of floor 132 and coupled thereto by one or more fasteners. In various embodiments, floor 132 is riveted, screwed, bolted, nailed or otherwise affixed to floor flange 128. In various embodiments, floor 132 is adhesively coupled to floor flange 128. Lid 104, cross member 108 (including any secondary cross members 136) may form cavities 140. Cavities 140 may be configured to encapsulate and support one or more batteries, battery modules, and/or battery packs.

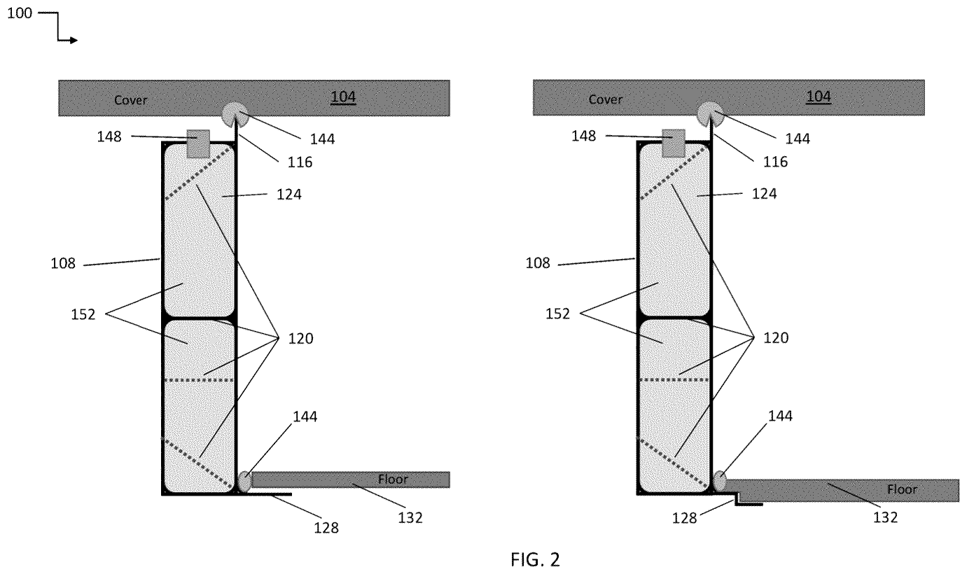

As shown in cross sectional view of FIG. 2, battery tray 100 generally includes a cross member 108 as shown and described. Cross member 108 may include flange 116 and floor flange 128 as shown in FIG. 1. Cross member 108 may include support ribs 120 as described above. Support rib 120 may be disposed diagonally internally from the upper inside corner of cross member 108, proximate flange 116 to the opposite vertical wall of cross member 108. In this arrangement, support rib 120 may transfer loads from the traverse direction (impacting the vertical wall of cross member 108) to the vertical direction (flange 116 and through lid 104) or vice versa. The support ribs 120 may be arranged as to transfer loads in a directional manner, such as to transfer transverse loads to vertical members, and vertical loads to transverse members. In various embodiments, support ribs 120 may be extend horizontally between walls of the cross member 108 at any angle, such as a 45 degree angle, 30 degree angle, or 60 degree angle. In various embodiments, support ribs 120 may be integral to cross member 108 and formed therein, or a separate component that is affixed to cross member 108. The internal structural components do not have to be regularly spaced or at any single point in all of the plurality of cross members—as denoted by the dashed line support ribs 120, which are located at a different depth/dimension than the solid-line support rib 120 in the cross sectional view shown. The cross member includes surfaces for sealing against the floor of the battery compartment in which it is disposed and with the lid or lid that is closed over top of the compartment

With continued reference to FIG. 2, cross member 108 may include one or more hollow 124 portion. Hollow 124 may encapsulate or receive a core 152. Core 152 may be one or more composite laminate components. In various embodiments, core 152 may be one or more solid foams, wood, plastics and/or rubber materials. In various embodiments, core 152 may be configured to crush a predetermined direction, and or depth, during an impact event, such as crumpled in a transverse or vertical direction. In various embodiments, a first core 152 may be disposed in a first hollow 124, the first core 152 having a first density. In various embodiments, a second core 152 with a second density may be disposed in a second hollow 124.

With continued reference to FIG. 2, battery tray 100 may include one or more gaskets 144. The cross member may include one or more sealing features including gaskets and plugs as shown herein. The cross member may have internal structural components disposed within it, spanning from interior wall to interior wall at a plurality of angles, depending on load needs. Gasket 144 may be disposed at any point in the assembly wherein two components are joined. For example and without limitation gasket 144 may be disposed between cross member 108 and lid 104. In various embodiments, gasket 144 may be disposed between flange 116 of cross member 108 and lid 104. In various embodiments, gasket 144 may be disposed within channel 112 disposed within lid 104, the gasket configured to receive flange 116 and provide a seal between lid 104 and flange 116 (or any portion of cross member 108 that engages therewith). Gasket 144 may be formed from rubber that deforms elastically to fill any gaps between engaging components, such as flange 116 and channel 112. In various embodiments, gasket 144 may be disposed between the horizontal upper side of cross member 108 and lid 104, sealing the gap therebetween against ingress or egress of fluids.

In various embodiments, battery tray 100 may include gasket 144 disposed between cross member 108 and floor 132. In various embodiments, gasket 144 may be disposed between floor flange 128 and floor 132, forming a seal therebetween. As shown in the embodiment on the right side of FIG. 2, the floor flange 128 can have a stepped (i.e. non-planar) configuration to receive a complimentary shaped floor 132. Gasket 144 may extend the entire length of the mating surfaces of floor 132 and floor flange 128. In various embodiments, gaskets 144 may be disposed periodically along the mating surfaces of the components it seals, located at the most critical points, such as larger gaps, proximate sensitive components or the like.

With continued reference to FIG. 2, battery tray 108 may include a plug 148. Plug 148 may seal any portion of cross member 108 that has an opening. For example and without limitation, if cross member 108 has an opening configured to allow internal access for maintenance, ingress of fluids or the like, plug 148 may be seated in said opening. In the embodiment shown, the plug 148 is disposed at the top surface of the cross member 108, but the plug can additionally/alternatively be located in the sidewalls. As shown, a space or gap can be provided between the cover 104 and the cross beam 108 to facilitate access to the plug 148.

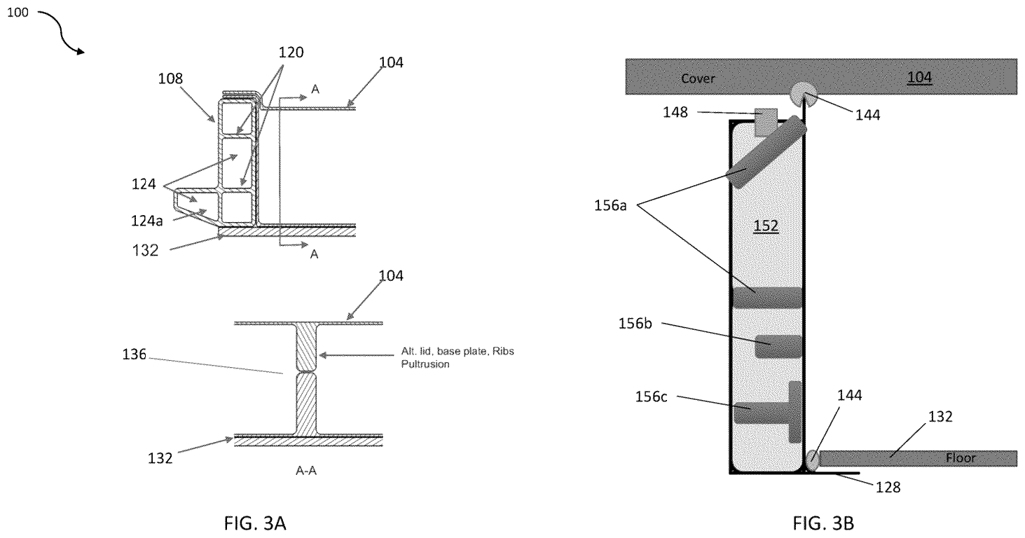

Referring now to FIG. 3A, cross member 108 is shown in cross-sectional view as in FIG. 2, with a varied arrangement of internal structural components such as the support ribs 120. The cross-member 108 may be a pultruded component or partially pultruded. The hollows/cavities 124 within the cross member 108 may include foams and/or cores 152 of a plurality of densities, alone or in combination. The base plate that acts as the floor 132 of the battery compartment may be pultruded or manufactured with internal structural components. Cross member 108 may include a lateral flange portion extending horizontally from cross member 108, the lateral flange configured to engage a component proximate the battery tray 100, such as a vehicle chassis. As shown in FIG. 3A, the cross member 108 can include a lateral flange, which is structed as a closed cell 124a, that extends both laterally outward and vertically upward.

In various embodiments lid 104 may have a protrusion extending therefrom toward floor 132 and floor 132 may be have a corresponding protrusion extending upwards toward lid 104, the protrusions configured to meet at a point therebetween and provide structural support to battery tray 100 and seal compartments from each other in battery tray 100.

In FIG. 3B, cross member 108 is shown in cross-sectional view with pins 156 disposed therein. Pins 156 may be discrete components formed from metallic materials. In various embodiments, pins 156 may be formed from aluminum or aluminum alloys. In various embodiments, pins 156 may be formed from metal alloys such as steel alloys tailored for the components use. In various embodiments, pins 156 may be formed from non-metallic materials such as various plastics, rubbers, composites or the like. In various embodiments, pins 156 may be formed from high density polyethylene (HDPE). In various embodiments, pins 156 may be formed from wood, such as wood from a single tree like oak, pine, ash, or the like. In various embodiments, pins 156 may be formed from wood sawdust, wood chips or various other wood composites pressed together or formed with a solidifying resin. In various embodiments, pins 156 may be formed from a single material in a single component. In various embodiments, pins 156 may be formed from more than one material, for example and without limitation, a first subset of pins 156 may be formed from plastic and a second subset of pins may be formed from metal, such as steel. In various embodiments, pins 156 may be formed from a material based on placement within cross member 108, for example and without limitation, metal pins located within the center portion of cross member 108 and plastic pins around the perimeter portion of cross member 108.

With continued reference to FIG. 3B, pins 156 may be a single size and shape, for example, each pin may be a cylinder or dowel-type shape with a single continuous surface connecting two circular end portions. In various embodiments, each pin 156 may have generally the same diameter. In various embodiments, each pin 156 may be formed with a rounded edge between the circular end portions and the cylindrical surface. In various embodiments, each pin 156 may be irregularly shaped along the length of the pin. For example and without limitation, pins such as pins 156a may be cylindrical with a continuous cylindrical surface having a single cross-sectional diameter. Pins 156a may be positioned horizontally within cross member 108 spanning through core 152 from vertical wall to vertical wall in an abutting/engaging arrangement. In various embodiments, pins 156a may be positioned diagonally from a vertical side of cross member 108 to the horizontal upper side of cross member 108, such as a portion of cross member 108 proximate flange 116. Pins 156 (a-c) may be utilized to increase crush performance of battery tray 100, for example pins 156 may be periodically disposed within cross member 108, randomly dispersed through cross member 108 in a parallel fashion, or both randomly dispersed and randomly oriented throughout the interior of cross member 108. In various embodiments, a plurality of pins 156 may be disposed throughout the length and height of cross member 108 that is to say that any portion of cross member 108 may have about an equal number of pins disposed therein. In various embodiments, cross member 108 may have a certain distribution of pins 156 throughout its length and height, based on particular impact responses or desired transfer modes.

In various embodiments, pins 156 may be distributed throughout cross member 108 based on a finite element analysis (FEA), wherein predicted failure modes are analyzed and pins are distributed throughout the cross member 108 based on the required strength required along the length, width and/or height according to said analysis. The pins are advantageous in that they allow for an impact load to be “redirected” from an initial load path to a deliberate path—so that the forces incurred are distributed away from the batteries. Thus a system of pins can be employed at discrete locations around the composite structure, rather than a continuous reinforcing web, which saves material and manufacturing cycle time.

In various embodiments, at least one pin may be a half pin 156b. The half pin may be disposed within cross member 108 wherein one side of the half pin 156b contacts a vertical wall of the cross member 108. In various embodiments, half pin 156b may be disposed within cross member 108, wherein no ends of the pin contact the vertical walls. In various embodiments, half pin 156b may be disposed horizontally within cross member 108, contacting at least one vertical wall at a right angle. In various embodiments, half pin 156b may be disposed within cross member 108 at an angle with respect to the vertical walls, wherein a first end of the half pin 156b contacting the vertical wall extending inwardly at an angle such as 30, 45 or 60 degrees. In various embodiments, a first portion of half pins 156b may be contacting a first vertical wall of cross member 108, and a second portion of half pins 156b may be contacting a second vertical wall of cross member 108, wherein each vertical wall of cross member 108 has a plurality of half pins 156b disposed thereon and extending inwardly. Half (or partial) pins 156b allow for some deformation of the composite structure, i.e. up to a predetermined depth/distance, but prevent complete collapse/failure of the structure.

In various embodiments, one or more pins may be have a head as shown in pin 156c. Pin 156c may have a cylindrical portion having a first diameter and a second cylindrical portion disposed at one end of the first cylindrical portion having a second larger diameter abutting either vertical wall of cross member 108. The larger diameter portion or head of pin 156c may have a circular cross section. In various embodiments, the head of pin 156c may have rectangular, oblong or other polygonal cross section. In various embodiments, the head of pin 156c may abut a vertical wall of cross member 108. In various embodiments, pin 156c may have two heads, each disposed at both opposite ends of the pin 156c, each head abutting or flush with a vertical wall of cross member 108. In various embodiments, pin 156c may have a head abutting flush with the cross member 108 vertical wall, having a pin body connected thereto at an angle, extending to the opposite vertical wall of cross member 108.

In various embodiments, cross member 108 or secondary cross member 136 may have a plurality of pins disposed therein at any portion along the length of each across battery tray 100 and in any distribution. Additionally or alternatively, each cross member 108 may have a plurality of various types of pins disposed therein, for example and without limitation, there may be a first amount of pins 156a, a second amount of pins 156b and a third amount of pins 156c dispersed throughout.

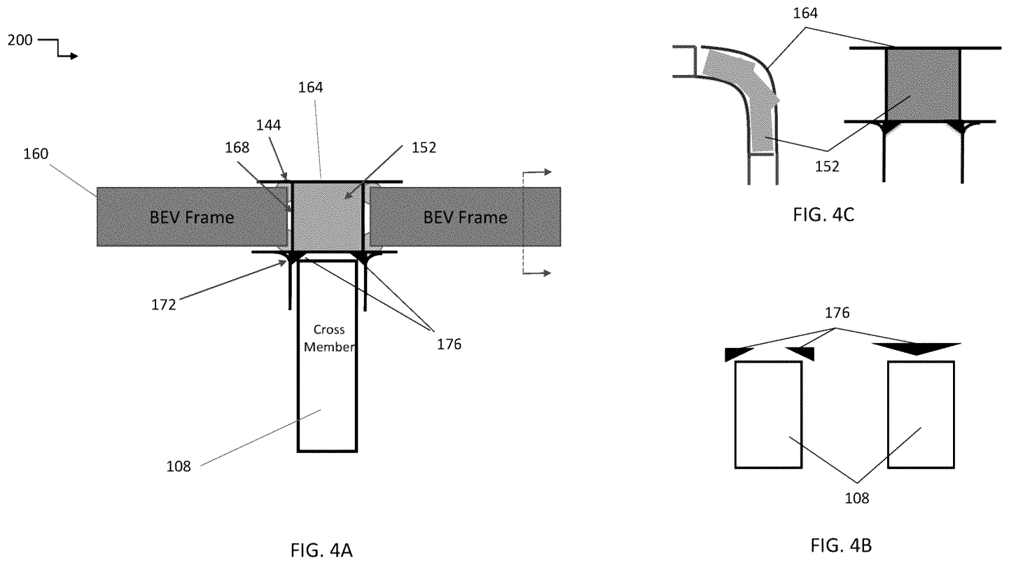

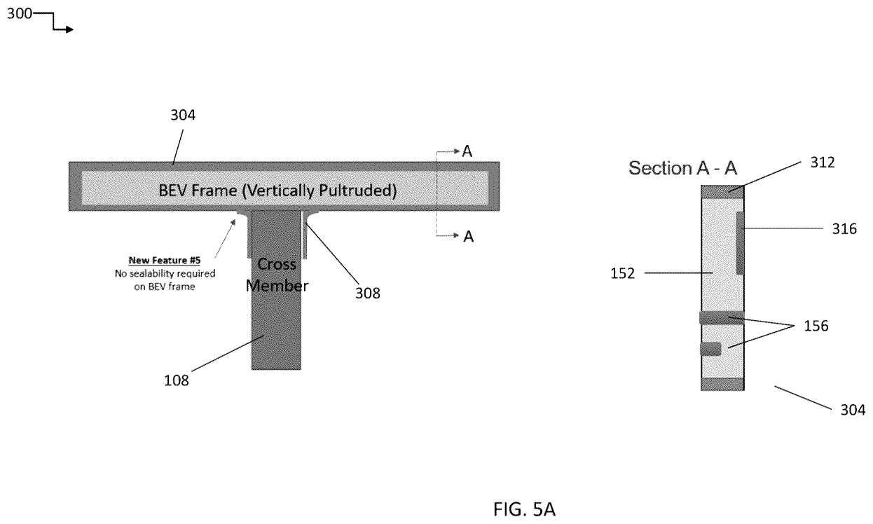

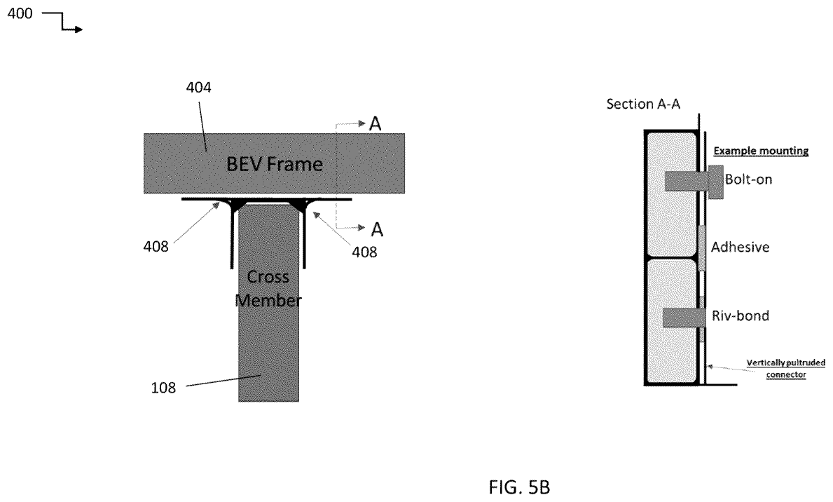

Referring now to FIGS. 4A-C, a node 164 of a composite structural frame (battery tray 100) is shown. The node 164 may be pultruded as one component or the entire nodal assembly may be pultruded. The node 164 includes off-axis (diagonal/corner) support 172 by integrating surfaces into node that are disposed on either side of the members 160 joined by the node. This feature also creates a U-shaped channel 168 where the member 160 meets the node 164 for incorporation with one or more gaskets (144) or other sealant features. U-shaped channel 168 may run orthogonal to channels 112 and be configured to receive a gasket or rubber sealing surface configured to create a liquid tight seal between member 160 and node 164.

Additionally or alternatively, the node 164 includes crush initiators 176 that maximize energy absorption through the members 108, 136, 160 when a load is applied. These crush initiators 176 may be geometrical features that impart a load on a member 108, 136, 160 such that the member crushes in a certain direction or crushes a certain amount to preserve one or more aspects of the battery nearby. This crush zone may be to safeguard the battery or to prevent explosions, fires, leaks, and the like. The nodal assembly as shown here is also configured to be modular. One or more nodes 164 may be swapped, one or more member 108, 136, 160 may be used depending on the configuration of the composite frame structure and integration into the electric vehicle.

Referring now to FIG. 4B, two types of crush initiators 176 are shown in cross section views (and with node 164 removed for visibility/clarity) with a partial view of cross members 108. Crush initiators 176 may be disposed at the corners of the node 164 and disposed opposite a corner of cross member 108 (or any member contacting node 164. Crush initiators 176 may be configured to initiate the crushing of the member from the corners thereof, manipulating the load transfer in an impact scenario and subjecting the member to one or more desired crush modes. In various embodiments, crush imitators may be configured to crush a portion of cross member 108 more than another portion, or control the direction of crush of the cross member 108. In various embodiments, crush initiators may be configured to bend, twist, shear or otherwise deform a member (like cross member 108) in an impact event, thereby deforming the member in a desired failure mode—protecting one or more sensitive or fragile components, like a battery, battery pack, battery module, sensors or the like. In various embodiments, there may be a crush initiator 176 at each corner of a node 164, a subset of corners of a node 164 or at another point on node 164. For example and without limitation, crush initiator 176 may be disposed at the point on the node 164 contacting a middle portion of cross member 108. The crush initiator 176 may be pointed, triangular, spade or pyramidal shape in order to puncture or concentrate force on the centerline of cross member 108. Thus, the crush initiator can have a first side with a smaller surface area than the second side, such that the forces absorbed are dissipated/distributed along the second/larger surface area when a force is exerted.

Referring now to FIG. 4C, two nodes are shown in cross sectional view, one being curved and one being rectangular as shown in FIG. 4A. The node 164 may be contourable to adhere to geometry constraints. The node geometry may be design to be curved, go around a corner, or other non-rectangular or regular arrangements.

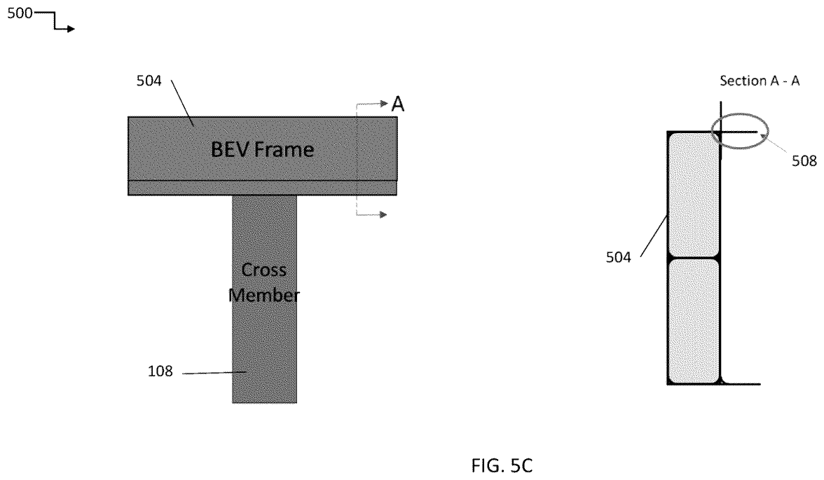

Referring now to FIG. 5A, a frame assembly 300 is shown in cross-sectional schematic view. Frame assembly 300 may include frame 300, which may be vertically pultruded. Frame 304 may include integral parts protruding therefrom. In various embodiments, cross member 108 meets the frame 304 at its midpoint, though other locations of cross members 108 and frame 304 attachment points can be included. Frame 304 has integral node 308 providing off-axis support in the form of flanges that run parallel and on either side of the cross member 108. Frame 304 may be pultruded with one or more endcaps 312 included therein, consistent with the description herein below. Frame 304 may be pultruded or manufactured with a plurality of composite or metal plates 316 disposed underneath its surface like tapping plates, among others. Such tapping plates allow for additional external components to be attached to the frame. Similar to the embodiments described above, frame 304 may include structural foam(s) 152 within its hollow volume, a solid cross-section, structural members, pins, fins, ribs, and the like. These internal structural members may span the length of the frame or a portion thereof.

Referring to FIG. 5B, a frame assembly 400 is shown in cross-sectional schematic view. Frame assembly 400 includes a separate pultruded bracket 408 and crush initiation support. The bracket 408 may be coupled to the frame 404 using mechanical fasteners, chemical coupling, or adhesive bonding, according to embodiments. The frame 408 in this variation may include sealing features where components are joined. The crush initiators (176) may be separately pultruded and coupled to the bracket 408 or pultruded with said bracket. In various embodiments, pultruded bracket 408 may replace one or more metallic brackets that would generally be used to couple the frame 404 and cross member 108.

Still referring to FIG. 5C, a frame assembly 500 is shown in cross-sectional schematic view. This variation of the frame 504 integration utilizes an additional horizontal flange 508 for cross member 108 retention and lid (104) sealability and support. The frame 504 may be pultruded with one or more flanges disposed on its surface and extended away perpendicular from the frame 504 at one or more portions along the frame's length. The flanges may be cross-member 108 mounting surfaces as well as provide seals against those cross-members 108 and the lid when closed. The flanges may be used as lid (lid 104) mounting surfaces for temporarily or permanently coupling the lid to the composite structural frame. The flanges may be used with a gasket or other sealing material so that the fit with the joining components creates a seal, or it may include geometry suitable for creating a seal in the absence of rubber gaskets.

Any of the composite frame structures discussed herein may include foams, pin support, metals, plastics or composite reinforcements for various applications (e.g. fastening, tailored load reinforcement, flame retardance, EMI shielding).

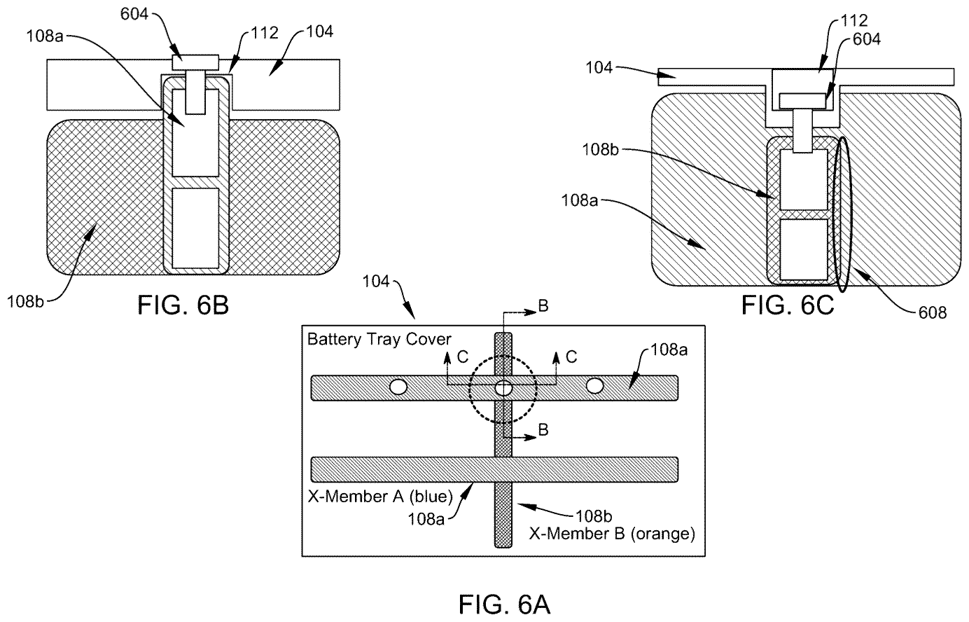

Referring now to FIG. 6A depicts a planform view of a frame 100 with joined cross members. FIGS. 6B and C depict cross sectional representations of joints between cross members and lids, according to embodiments of the disclosed subject matter. Cross members 108 of a frame structure 100 may include lid sealability features and robust connection features. Within vehicles, storage space is a premium. However, where cross members 108 intersect, there is a need for a robust joint for stiffness and impact. FIG. 6A depicts the assembly from the top-down or bottom-up wherein the cross members 108 are coupled where they cross each other, or intersect, and the horizontal cross-member on top is coupled to the lid. Composite cross member intersection design using a core material to structurally support the smaller member. Extension of the intersection design where the lid is contoured to match the geometry of the frame wherein the benefits include structural stiffness, optimal fastener design and locations.

Referring specifically to FIG. 6B, a cross sectional view of a cross member and lid joint is shown in schematic representation. Cross member 108a may be filled with foam to provide a contact surface for robust connection on the long or short side of cross member 108. For example and without limitation, the foam may be configured to be penetrated by one or more mechanical fasteners 604. The frame sits transverse and behind the cross member 108a. The cover or lid 104 may sit on top of the cross member 108a and includes a cut-out, or recess, much like channel 112, where the cross member 108a or a portion thereof may seat inside, as shown in the exemplary embodiment of FIG. 6B. In other words, cross beam 108a of FIG. 6B can include a male portion that is received by a complimentary shaped female portion of the lid 104. The lid 104 may then be mechanically fastened or coupled to cross member 108a in a plurality of methods herein described.

Referring to FIG. 6C, a cross sectional view of a cross member and lid union is shown in schematic representation. Cross member 108b is shown in cross-sectional view once more, but the lid 104 is contoured (e.g. includes a female surface feature) to meet the lower cross-member 108b where they abut against each other. In other words, and contrary to cross member 108a of FIG. 6B, the frame 108b can include a recess/channel to receive a male portion of the lid 104. The lid 104 may then be coupled to the cross member 108. The cross members 108 may be coupled to one or more other cross members or components using weldable resins 608. The contouring of the lid 104 may be configured to minimize the total volume of the composite frame structure (100).

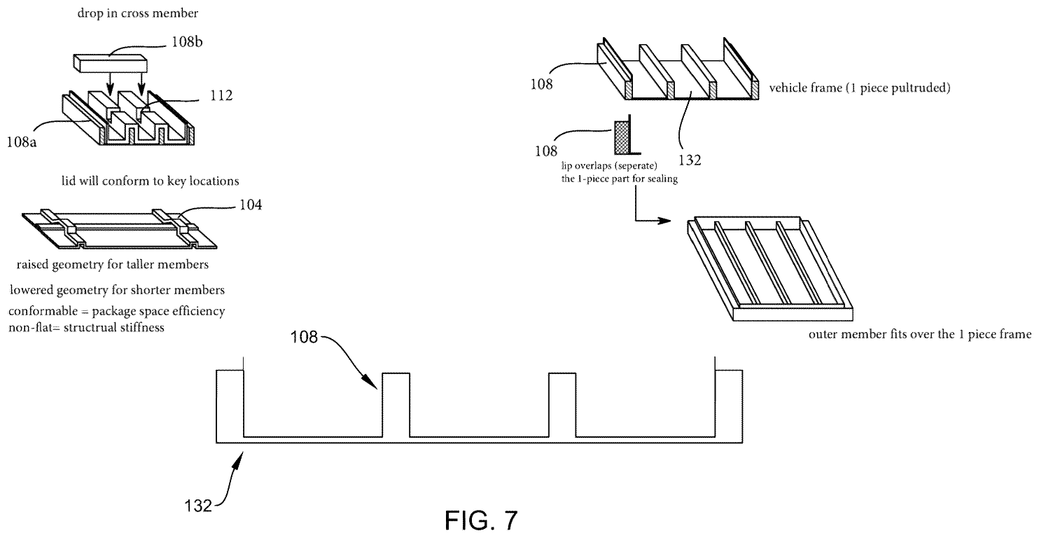

Referring now to FIG. 7, a schematic representation of cross members 108 of a frame structure including sealability features and cutouts for cross member connection is presented. In various embodiments, floor 132 and at least a portion of cross members 108 may be formed (e.g. via pultrusion) as a continuous component. In various embodiments, floor 132 and all the cross members 108 may be formed as a single continuous component. In various embodiments, floor 132 and a single cross member 108 may be formed as a single continuous component. In various embodiments, floor 132 and the outermost cross members 108 may be formed as a single continuous component. Variations of the above designs where the floor 132 and at least a set of cross members 108 may be pultruded as a single component. The single component design can include any sealing or structural features as described above, including the above lid 104 sealability designs and intersection designs. The floor 132 or lid 104 of the battery compartment may be pultruded or otherwise manufactured with an integral set of cross members 108 such that no sealing is required as it is all a single continuous component. This integral cross-member lid 104 or floor 132 may then be coupled to the above-mentioned components utilizing sealing features. For example and without limitation, the cross members 108 disposed at the ends of the integral lid 104 or floor 132 may include flanges to seat the other components such as the frame into it and create a seal with the gasket. Any of the components, assemblies, or materials described herein have a resin option where the members are phenolic for fire protection.

Additionally, in some embodiments the battery tray 100, including any cell walls, can have access features (e.g. apertures, grooves, etc.) formed therein to allow conduits and interconnections between neighboring cells such as wiring to/from the batteries contained within the cells. Similarly, these access features can serve as a ventilation means between battery cells. In some embodiments it may be desirable to direct a fluid flow through such access features to provide heating or cooling of the cells. Furthermore, in some embodiments the composite enclosure can include an access point, e.g. for technicians to replace equipment having a limited life cycle such as fuses, printed circuit boards, connectors, control equipment, etc. The access point can be formed as a resealable panel which can be opened by sliding along a horizontal axis of the enclosure, by pivoting about a hinge formed in the enclosure, or by being removed from the remainder of the enclosure. In some embodiments, the access point (and underlying replaceable equipment) is located in a compartment that is segregated from (i.e. not open to, nor in fluid communication with) the cells containing batteries. This configuration ensures a hermetic seal is maintained at all times (i.e. even when the access panel is open) between the batteries and the ambient air.

Furthermore, although the exemplary embodiments illustrated herein depict a generally rectangular enclosure with constant thickness, alternative designs can be provided, e.g. battery enclosures having varied (tapered or stepped) width and/or height to accommodate both the battery capacity desired, and the vehicle chassis design dictating how and where the battery enclosure is to be coupled.

In some embodiments, a plurality of composite battery enclosures as described above, can be combined in a modular fashion, e.g., vertically stacked on top of each other to increase battery capacity. Such stacking increases the mass, and thus dampens any undesired vibratory loads, as well as increases the rigidity of the aggregate structure. Moreover, the composite battery enclosures of the present disclosure can be retrofitted to a previously formed vehicle chassis.

In accordance with another aspect of the disclosure, the composite battery enclosures described herein can incorporate electromagnetic shielding properties. In some embodiments the electromagnetic shielding can be provided around the exterior of the enclosure. In some embodiments the electromagnetic shielding can be provided around select cells (individual or plurality) of the enclosure. The presence of such EMF/EMC shielding inhibits any undesired electrical interference between the battery and other components of the vehicle.

In accordance with yet another aspect of the disclosure, the composite enclosures described herein can be formed from a plurality of “functionally graded” laminates, i.e., each laminate serving a specific and discrete function. For example, the composite can have a first laminate layer a layer (or plurality of layers) of carbon nano-tube enriched (e.g. graphene) composite plies to create an electrically conductive surface that acts both as a ground plane, as well as providing electromagnetic shielding functionality. Additionally, a layer of phenolic matrix composites can be formed on the interior of the enclosure to provide a thermal barrier which protects against thermal runaway of a battery as well as preventing catastrophic failure. Furthermore, an armour layer composed of aramid, crystalline polyethylene, or Dyneema, can be incorporated to provide local impact (penetration) protection, etc.

### Embedded End Cap Pultrusion

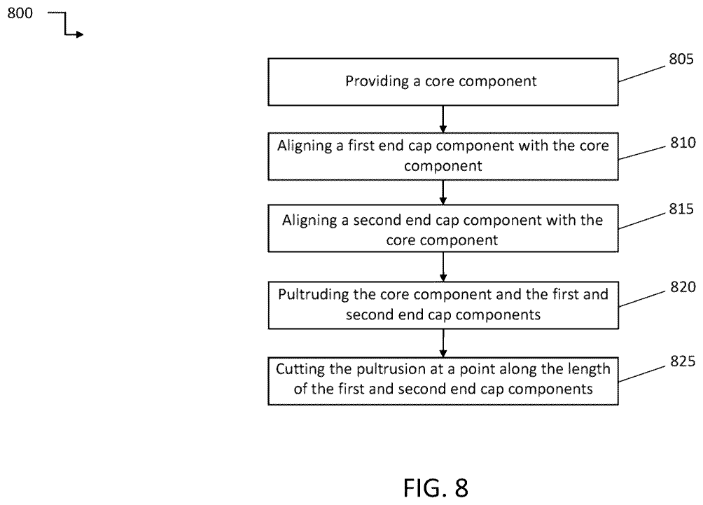

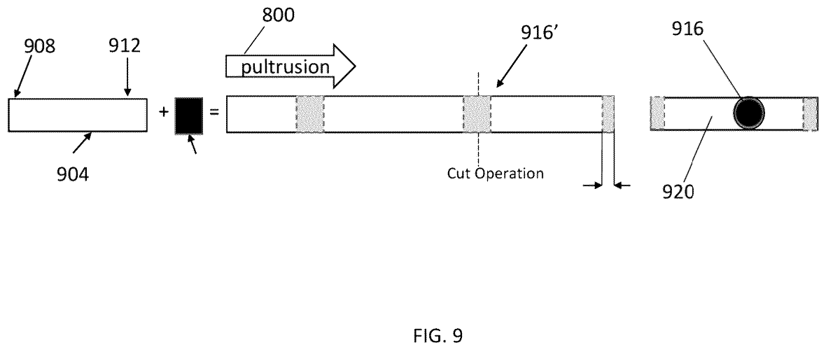

Referring now to FIGS. 8-9, a method 800 for integrated end caps for pultrusion is shown in flow chart form. Method 800, at step 805, includes providing a core component 904, wherein the core component 904 includes a first end 908 and a second end 912 disposed oppositely on a substantially long and thin body. The core component 904 may include a foam such as structural foam. In various embodiments, core component 904 may include a cross section shape such as octagonal, rectangular, hexagonal, square, oblong, or circular, according to embodiments.

Method 800, at step 810 includes aligning a first end cap 916 component with the core component 904. Any end cap component 916 may be the same or similar cross sectional shape as the core component, according to embodiments. The first and/or second end cap component 916, may include the same dimensions as the core component 904. For example and without limitation, the end cap component 916 may span the cross section area of the core component, along the long and short faces of a core component, or any other portion thereof. For example and without limitation, the core component 904 may be formed as a sheet, wherein the end cap component 916 may fully lids the core component 904 on any face in the direction of pultrusion. The end cap components 916 may be constructed from a metal, thermoset, thermoplastic, or a combination thereof, among others.

Method 800, at step 815 includes aligning a second end cap component 916 with the core component 904. The second end cap component 916, or any end cap as described herein, may be the same or similar cross sectional shape as the core component 904, according to embodiments. The first and/or second end cap component 916, may include the same dimensions as the core component 904. For example and without limitation, the end cap component 916 may span the cross section area of the core component, along the long and short faces of a core component, or any other portion thereof. For example and without limitation, the core component 904 may be formed as a sheet, wherein the end cap component 916 may fully lids the core component 904 on any face in the direction of pultrusion. The end cap components 916 may be constructed from a metal, thermoset, thermoplastic, or a combination thereof, among others.

These materials may enable additional functionalities such as tapped locations, lids, sensors, wire terminations, terminals, or electrical traces. The end cap component may include one or more functionalities based on integral components such as one or more sensors or one or more connection terminals.

The method 800, at step 820, includes pultruding the core component 904, the first end cap component 916 and second end cap component 916, wherein the first end cap component 916 is disposed at a first end 908 of the core component 904, and the second end cap component 916 is disposed at the second end 912 of the core component. Pultrusion is a continuous process where the core component 904 is pulled along behind and abutting the first end cap component 916 and immediately in front of and abutting the second end cap component 916. The method 800 may include the application of pressure in the pultrusion process as well as resin soaking, coating, impregnation, or the like. The first and/or second end cap 916 may be coupled to at least a portion of the core component 904 by mechanical fasteners, resin welding, chemical bonding, adhesive bonding, or other methods of coupling.

The method 800, at step 825 includes cutting the pultrusion 920 at a point along the length of the first and second end cap components 916 wherein the end cap encapsulates the core component 904 along the cut point. That is to say that the cut is made at some point along the end cap component 916 such that the core component 904 that immediately precedes or succeeds the end cap component 916 in the pultrusion process each has a portion of the end cap component 916 embedded within its end, as shown in FIGS. 9, 10, and 11. In other words, although end cap component 961′ is a single component during the pultrusion process, thereafter it is cut (e.g. at its midpoint) to effectively form two end caps—each of which is coupled to an adjacent frame, and each end cap having mirroring geometry. The end cap components 916 are embedded in pultruded components with cores that could be corroded or damaged if unprotected at the ends. The end cap components may include seals around the edges where they meet and are coupled to the core component 904.

The method 800 may include cutting the pultrusion 920 at a non-normal angle. The end cap may be cut at a 45 degree angle thus creating a mirror image end cap 916 immediately preceding it. The end cap may create a seal with the core component regardless of cut angle.

Referring now to FIGS. 9, 10 and 11, exemplary schematic representations of the pultrusion method of FIG. 8 is shown. In FIG. 9, core component 904 is shown as a generally elongate body with a first end 908 disposed oppositely from the second end 912. Core component 904 may have a continuous cross sectional shape that is consistent and equal throughout the length of the core component 904. In various embodiments, core component 904 may have a variable cross sectional shape over its length from first end 908 to second end 912. In various embodiments, first end 908 and second end 912 have the same cross sectional shape. In various embodiments, first end 908 and second end 912 have a different cross sectional shape. In various embodiments, first end 908 and second end 912 have the same shape and a varying cross sectional area. In various embodiments, first end 908 and second end 912 have the same shape and the same cross sectional area. In various embodiments, core component 904 is a solid foam material. In various embodiments, core component 904 is hollow from the first end 908 to the second end 912. In various embodiments, core component 904 may have various hollows or cavities disposed therein. In various embodiments, core component 904 may have a variable internal diameter along its length, thereby have a variable sized continuous hollow from the first end 908 to the second end 912. In various embodiments, core component 904 may be formed from one material. In various embodiments, core component 904 may be formed from a plurality of materials. In various embodiments, that plurality of materials may be mechanically bonded prior to the pultrusion process. In various embodiments, that plurality of materials may be chemically bonded prior to the pultrusion process. In various embodiments, core component 904 may be formed as a multi-material assembly.

With continued reference to FIG. 9, pultrusion 920 has at least one end cap component 916. End cap component 916 may be formed from one or more metals or metal alloys. In various embodiments, end cap component 916 may be formed from one or more thermosets and/or thermoplastics, alone or in combination. In various embodiments, end cap component 916 may be include one or more plates formed from metal or plastic that serve to mount one or more components thereon. In various embodiments, end cap component 916 may have one or more closeable openings, hatches or passthroughs for internal access to the core component 904. In various embodiments, end cap component 916 may be formed from a variety of rubbers, alone or in combination. In various embodiments, end cap component 916 may include embedded sensors (such as an RFID or thermoelectric device). In various embodiments, end cap components 916 may include one or more electrical terminals and/or one or more leads for electrical connections before, during or after manufacturing. In various embodiments, any one or more embedded components may be revealed after the cut operation inside end cap components 916. The pultrusion 920 in FIG. 9 is shown as a single body with a single hollow that is capped on both ends by end cap components 916. This representation should not limit the possible configurations of core components and end cap components.

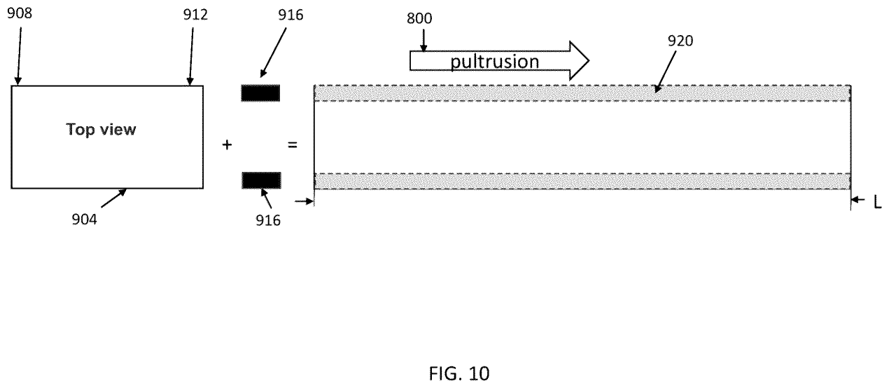

Referring now to FIG. 10, core component 904 is shown as a generally elongate body with a first end 908 disposed oppositely from the second end 912. Unlike FIG. 9, core component 904 is aligned with two end cap components 916 on a single side, thus provided seals for two internal parallel hollows of core component 904. The core component 904 has two hollows on either terminating long side of the core component 904. The end cap components 916 therefore seal the short sides of the core component 904 after the pultrusion process.

Core component 904 may have a continuous cross sectional shape that is consistent and equal throughout the length of the core component 904. In various embodiments, core component 904 may have a variable cross sectional shape over its length from first end 908 to second end 912. Core component 904 may be continuous or solid between the two long edges, thus not requiring sealing by integral end cap components 916. In various embodiments, first end 908 and second end 912 have the same cross sectional shape. In various embodiments, first end 908 and second end 912 have a different cross sectional shape. In various embodiments, first end 908 and second end 912 have the same shape and a varying cross sectional area. In various embodiments, first end 908 and second end 912 have the same shape and the same cross sectional area. In various embodiments, core component 904 is a solid foam material.

In various embodiments, core component 904 is hollow from the first end 908 to the second end 912. In various embodiments, core component 904 may have various hollows or cavities disposed therein. In various embodiments, core component 904 may have a variable internal diameter along its length, thereby have a variable sized continuous hollow from the first end 908 to the second end 912. In various embodiments, core component 904 may be formed from one material. In various embodiments, core component 904 may be formed from a plurality of materials. In various embodiments, that plurality of materials may be mechanically bonded prior to the pultrusion process. In various embodiments, that plurality of materials may be chemically bonded prior to the pultrusion process. In various embodiments, core component 904 may be formed as a multi-material assembly.

With continued reference to FIG. 9, pultrusion 920 has at least one end cap component 916. End cap component 916 may be formed from one or more metals or metal alloys. In various embodiments, end cap component 916 may be formed from one or more thermosets and/or thermoplastics, alone or in combination. In various embodiments, end cap component 916 may be include one or more plates formed from metal or plastic that serve to mount one or more components thereon. In various embodiments, end cap component 916 may have one or more closeable openings, hatches or passthroughs for internal access to the core component 904. In various embodiments, end cap component 916 may be formed from a variety of rubbers, alone or in combination. In various embodiments, end cap component 916 may include embedded sensors (such as an RFID or thermoelectric device). In various embodiments, end cap components 916 may include one or more electrical terminals and/or one or more leads for electrical connections before, during or after manufacturing. In various embodiments, any one or more embedded components may be revealed after the cut operation inside end cap components 916. The pultrusion 920 in FIG. 9 is shown as a single body with a single hollow that is capped on both ends by end cap components 916. This representation should not limit the possible configurations of core components and end cap components.

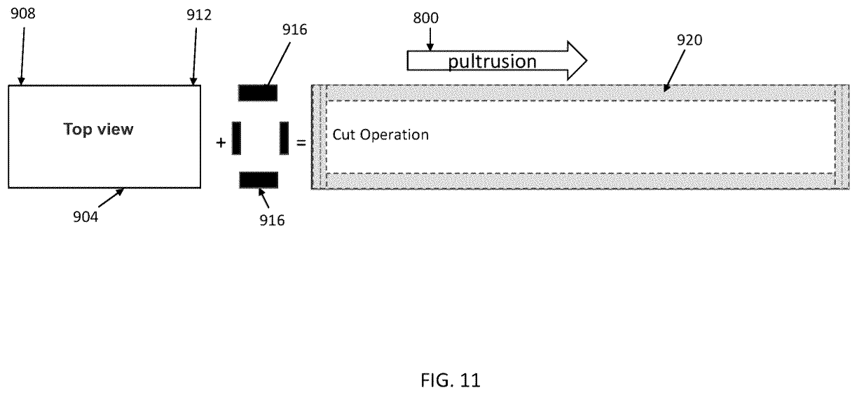

Referring now to FIG. 11, core component 904 is shown as a generally elongate body with a first end 908 disposed oppositely from the second end 912. Core component 904 is much like the core component as shown in reference to FIG. 10. In this embodiment, core component 904 is a continuously hollow throughout. In this process, end cap component 916 is disposed along both long edges as to seal a portion of core component 904 proximate the long edges and two end cap components 916 to seal the short sides of pultrusion 920 proximate the first end 908 and the second end 912.

Core component 904 may have a continuous cross sectional shape that is consistent and equal throughout the length of the core component 904. In various embodiments, core component 904 may have a variable cross sectional shape over its length from first end 908 to second end 912. Core component 904 may be continuous or solid between the two long edges, thus not requiring sealing by integral end cap components 916. In various embodiments, first end 908 and second end 912 have the same cross sectional shape. In various embodiments, first end 908 and second end 912 have a different cross sectional shape. In various embodiments, first end 908 and second end 912 have the same shape and a varying cross sectional area. In various embodiments, first end 908 and second end 912 have the same shape and the same cross sectional area. In various embodiments, core component 904 is a solid foam material.

In various embodiments, core component 904 is hollow from the first end 908 to the second end 912. In various embodiments, core component 904 may have various hollows or cavities disposed therein. In various embodiments, core component 904 may have a variable internal diameter along its length, thereby have a variable sized continuous hollow from the first end 908 to the second end 912. In various embodiments, core component 904 may be formed from one material. In various embodiments, core component 904 may be formed from a plurality of materials. In various embodiments, that plurality of materials may be mechanically bonded prior to the pultrusion process. In various embodiments, that plurality of materials may be chemically bonded prior to the pultrusion process. In various embodiments, core component 904 may be formed as a multi-material assembly.

### Multi-Resin Pultrusion

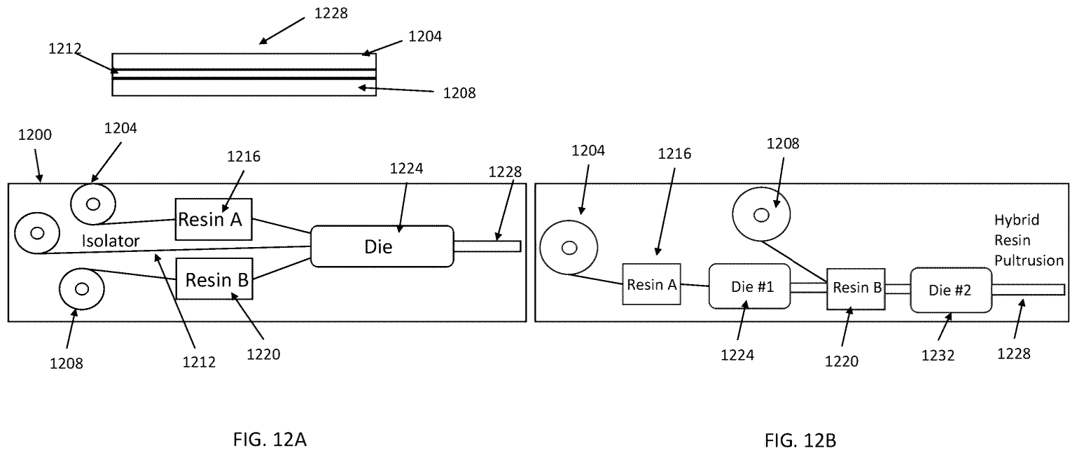

As shown in FIG. 12A, the system 1200 includes a first material 1204 disposed unwrappably on a first spool and configured to be pulled from one end through at least a portion of the downline components. The system includes a first resin 1216 disposed downline from the first material 1204 comprising at least an opening and configured to allow the first material 1204 to be pulled at least partially through the first resin 1216. The first resin 1216 may be a resin bath, resin spray, resin injection site, or the like. The system 1200 includes a second material 1208 disposed unwrappably on a second spool and configured to be pulled from one end parallel to and in the same direction as the first material 1204 through at least a portion of the downline components. The system includes a second resin 1220 disposed downline from the second material 1208 including at least an opening and configured to allow the second material 1208 to be pulled at least partially through the second resin 1220. The second resin 1220 may be any resin applicator, such as the same resin applicator as the first resin 1216. The first resin 1216 and second resin 1220 may include different resins altogether, or partially different resins having some common components.

The system 1200 also includes an isolator material 1212 disposed unwrappably on a third spool disposed in between the first material 1204 and the second material 1208 and configured to be pulled parallel to and in the same direction as the first material 1204 and the second material 1208. The isolator material 1212 is configured to completely isolate the materials and resins from the other in the die 1224. In some embodiments, each of these spools dispense material (i.e. 1204, 1208, 1212) at the same rate/speed such that each material passes through its respective resin, (1216, 1220) and the die 1224, at a uniform speed.

The system also includes a die 1224 disposed downline from the first material 1204, the second material 1208, and the isolator material 1212 configured to impart a cross sectional shape to the first material 1204, the second material 1208 and the isolator material 1212 therebetween as they are pulled through the die 1224. In various embodiments, the resin systems are both liquid and use the traditional pultrusion process. Components may require different functionalities on different sides of the part. In the case of resins, this can be a limiting factor (e.g. flame retardance on side A and UV stable on side B). Components may also require geometric features limited by a single-die process. This can be a limiting factor (e.g. impact members of a BEV).

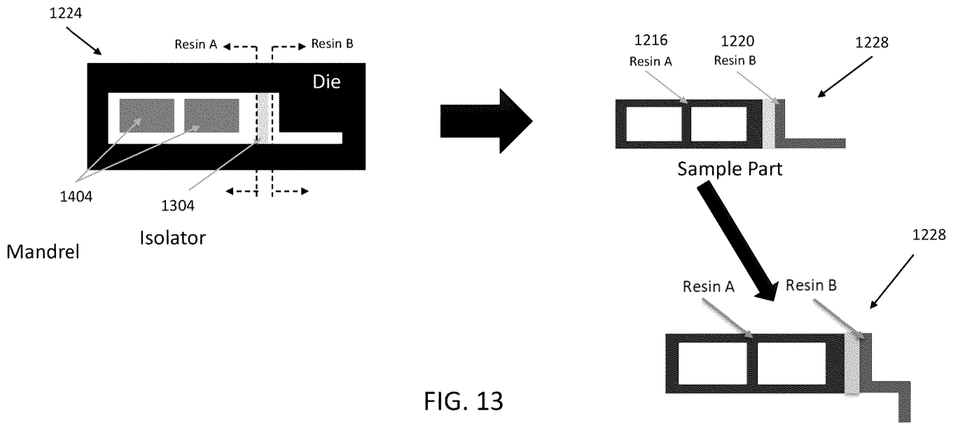

The system of may include a die 1224 wherein the die includes a first cavity and a second cavity separated therebetween by a wall 1304 such as in FIG. 13. The wall 1304 may be an isolator layer (e.g. cores, films, tool features) to prevent resins from interacting in critical locations. The first resin 1216 is configured to be injected into the first cavity and pulled through the die as a solid. The second resin 1220 is configured to be injected into the second cavity and pulled through the die 1224 as a solid. Then the hybrid resin pultrusion 1228 is pulled through the die wherein the hybrid resin pultrusion 1228 is the coupled first resin 1216 and second resin 1220.

Referring now to FIG. 12B, another embodiment of a system 1200 for multi-resin pultrusion includes a first material 1204 disposed unwrappably on a first spool and configured to be pulled from one end. The system 1200 includes a first resin 1216 disposed downline from the first material 1204 including at least an opening and configured to allow the first material 1204 to be pulled at least partially through the first resin 1216. The system 1200 includes a first die 1224 disposed downline from the first material 1204 configured to impart a cross sectional shape to the first material 1204 as they are pulled through the die 1224. The system 1200 includes a second material 1208 disposed unwrappably on a second spool disposed downline of the first die 1224 and configured to be pulled from one end along with and abutting to the first material 1204. The second material 1208 may also be a film or material with an adhesive to create inline bonding and/or chemical bond with a second resin 1220. The system 1200 includes the second resin 1208 disposed downline from the first die 1224 including at least an opening and configured to allow the first material 1204 and second material 1208 to be pulled at least partially through the second resin 1220.

Still referring to FIG. 12B, the system includes a second die 1232 disposed downline from the second resin 1220 configured to impart a cross sectional shape to the first and the second material 1204, 1208 as they are pulled through the second die 1232. The second die 1232 may also take a new shape and/or make shapes otherwise non-pultrudable in a single die. In an embodiment, this could be modified such that the second resin 1220 system is applied on a B-stage cured system. In another embodiment, this could be modified to apply a spool of film or material with a bonding agent on a surface to connect to the original pultrusion component.

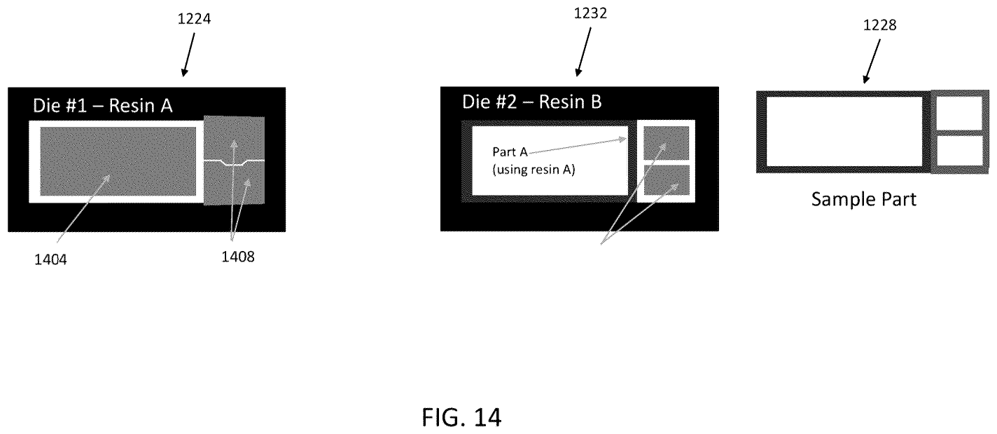

Referring now to FIGS. 13-14, the system 1200 may include a first die 1224 that has a first mandrel 1304 configured to force the first resin/material 1204 into a first area and a blocking mandrel 1408 configured to prevent the first resin/material to enter a second area. The system 1200 may also include a second die 1232 that has the blocking mandrel 1408 which tapers down to a smaller cross sectional area, therefore allowing the second resin/material 1220 to enter a second area and the first resin 1216 has since cured therefore preventing the second resin to enter the first area. In an embodiment, this could be done using a parallel bath, injection box or b-stage cured system. In another embodiment, this could be done by using multiple sequential dies in series. Where the second die 1232 adds a unique value, a third adds another and so on as needed (e.g., liquid, b-stage, or film/bonding agent system). In yet another embodiment, the dies downline from at least a first die could be specifically designed to enable pushing the limits of pultrusion (e.g. undercuts, die-lock scenarios, thickness ratios, fiber control limitations). In yet another embodiment, the mandrels used to prevent resin from entering certain areas may be used to cut off zones in the die to further create hollow sections in future dies.

Thus the multiple material/resin and die pairing allows for pultruded components to be formed that have different materials, and different geometries, yet are formed as a single-integral component. For example, the exemplary cross beams shown on the right side of FIG. 13 can have the hollow portions formed of Resin A, and have generally rectangular shape, while the flange portion can be formed of Resin B and have an L-shaped configuration. Accordingly, the multiple dies can be employed when pultruding the composite battery tray components described above with respect to FIGS. 1-7.

The preferred setting is in transportation components where a combination of the following is necessary in local segments but not through the entire part (UV stability, aesthetic quality, pigmentation, flame retardance, fracture mitigation). All embodiments could apply in the wind industry for pultruded components (e.g. Nacelles). Some embodiments described herein could enable solutions across high end composite solutions (e.g Aerospace) where B-stage prepregs, films are more are used. Especially as pultrusion is a significant cost decrease, but requires tighter process control, lower void content, and uses thinner lamina.

Additional components, geometries and materials can be included in the pultrusion system and methods disclosed herein, including the features disclosed in PCT/US21/54786, the entire contents of which are hereby incorporated by reference.

### Fiber Metal Laminate

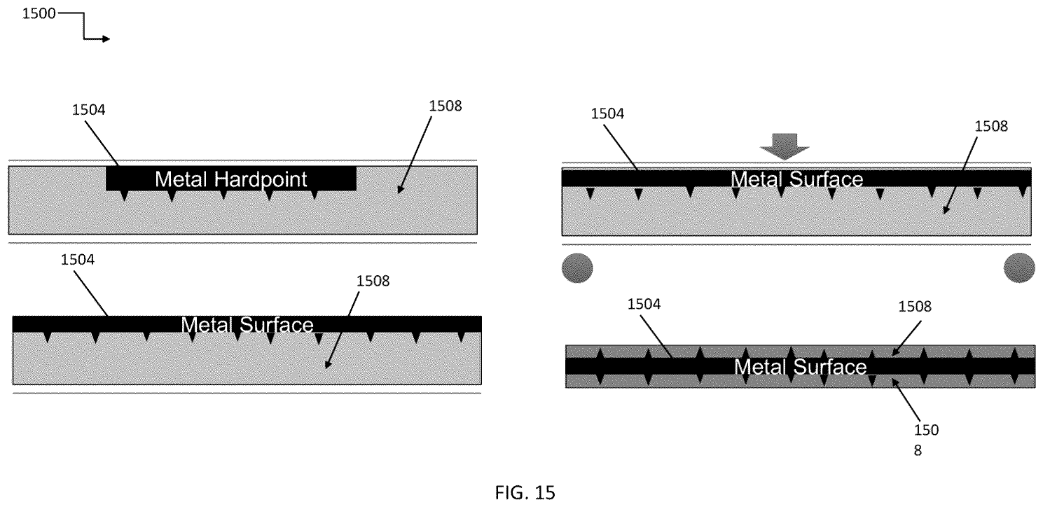

As shown in FIG. 15, the system 1500 for fiber metal composites generally includes a metallic component 1504. The metallic component 1504 may be aluminum or aluminum alloys, steel or steel alloys, other metal elements and/or combinations thereof. The metallic component 1504 includes a plurality of protrusions coupled to at least a portion of the metallic component 1504 at a proximal end and free at a distal end. The plurality of protrusions may be disposed on one face of the metallic component 1504, one side in embodiments where the metallic component 1504 is a sheet, or other portion thereof. For example, metallic component 1504 may include a plurality of protrusions in a pattern on one face, on opposite faces, or on its entire surface area. The plurality of protrusions may be disposed in regular columns, rows, grids, or be randomly placed within a perimeter on the metallic component's surface area. In embodiments, the plurality of protrusions may include metal hooks or spikes to interlock with the polymer matrix composite vehicle component 1508 (the fiber component). These protrusions facilitate coupling to the composite component (and increase the surface area in contact between the two to increase frictional forces and create a stronger bond therebetween).

The system further includes a fiber component 1508 disposed directly adjacent to the metallic component 1504 wherein the fiber component 1508 is at least partially punctured by the distal end of the plurality of protrusions. The fiber component 1508 may be a polymer matrix composite vehicle component. The fiber component 1508 may be a plastic or set of plastics. The fiber component 1508 may be directly abutting the surface of the metallic component 1508. The fiber component 1508 may be partially abutting the surface of the metallic component 1504 leaving overhang where the two components are not directly touching. The fiber component 1508 may be a vehicle component wherein a metallic component 1504 is embedded or interconnected with a polymer matrix composite product during the manufacturing process. The metallic component 1504 has metallic hooks or spikes to create a mechanical interlock within the composite.

According to embodiments, the metallic component 1504 is molded to be one side of the vehicle component to stabilize failure mechanisms, reinforce key loads, or otherwise be a functional surface requiring a metal plate (e.g. coatings, heat transfer). That is to say that the metallic component 1504 and fiber component 1508 are arranged and shaped such that after permanently coupling together, the metallic component 1504 lids the portion of fiber component 1508 such that exterior is fully metallic (suitable for painting and the like). In various embodiment, the vehicle component uses the mechanical interlock to fix itself to the core material prior to manufacturing and is molded over. In this embodiment, the metallic component 1504 and the fiber component 1508 act as a core for other material to be laid on top and surrounding the fiber metal composite laminate.

In another embodiment, the molding process is pultrusion. During the pultrusion process high pressure resin-transfer molding, compression molding, or vacuum assisted resin transfer molding may be utilized to impregnate the fiber composite 1508 to be cured at a later stage after coupling with the metal laminate. The metallic component 1504 may molded to be a connection point (welding, fastening, flow drill screw, etc) to another metallic product. That is to say that the metallic component 1504 may be coupled to the fiber component 1508 such that the metallic component 1504 could be further coupled to another component by means that require a metal surface (like welding), thereby coupling the fiber component 1508 along with it.

In another embodiment, the metallic component 1504 may include a plurality of protrusions on two opposite and opposing surfaces. The fiber component 1508 would then be coupled to each side of this metallic component 1504, effectively creating a metallic core to a fiber composite laminate. The metallic component would be molded to be a sub layer component and provide a z-pinning effect to prevent interlaminar shear in key layers and/or to increase energy absorption capability during failure. The fiber metallic composite 1500 may be used as a vehicle component that is used to absorb energy in an impact event (e.g. battery tray frame, vehicle panels, impact beams). The metal reinforced composite structures of FIG. 15 can be employed in the battery tray embodiments disclosed herein—e.g. in the cover, base plate, and/or cross beams, etc.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A system for a composite battery tray structure, the system comprising:
a floor extending in a longitudinal and transverse direction, the floor configured to receive at least one battery,
at least one cross member disposed on the floor and extending in the transverse direction, the at least one cross member having a top surface, bottom surface and sidewalls extending vertically therbetween,
the at least one cross member having a first flange extending vertically upward from the top surface,
the at least one cross member having a second flange extending laterally from the bottom surface,
the at least one cross member being hollow, with a support rib extending between the sidewalls;
a lid disposed above the cross member, the lid having a channel extending upward, the channel configured to receive the first flange of the at least one cross member.

2. The system of claim 1, wherein the second flange is configured to engage at least a portion of the floor.

3. The system of claim 1, wherein the at least one cross member creates a seal with the floor via a gasket disposed therebetween.

4. The system of claim 1, wherein the at least one cross member creates a seal with the lid via a gasket disposed therebetween.

5. The system of claim 1, wherein the at least one cross member includes a core component disposed therein.

6. The system of claim 1, wherein the at least one cross member has at least one pin disposed therein, the at least one pin extending laterally within the at least one cross member.

7. The system of claim 8, wherein the at least one pin extends from a first side wall to a second sidewall within the cross member.

8. The system of claim 8, wherein the at least one pin extends from a first side wall at a non-normal angle therefrom.

9. The system of claim 8, wherein the at least one pin has a first cylindrical portion having a first diameter, and a second cylindrical portion having a second diameter, the first diameter being larger than the second diameter, the first cylindrical portion abutting a first side wall of the cross member.

10. A method of forming integrated end caps, the method comprising:
providing a first core component, the first core component comprises a first end and a second end;
positioning the first core component between a first end cap component and a second end cap component, the first and second end cap components having substantially the same cross-sectional thickness as the first core component;
providing a second core component, the second core component having a first end and a second end;
positioning the second core component between a third end cap component and a fourth end cap component, the third and fourth end cap components having substantially the same cross-sectional thickness as the second core component;
pultruding the core components with the end cap components to form a pultruded assembly, the first end cap component disposed at a first end of the core component, and the second end cap component disposed at the second end of the core component;
cutting the pultruded assembly at a point along the second end cap component.

11. The method of claim 10, wherein cutting the pultrusion comprises cutting the pultrusion at a non-normal angle.

12. The method of claim 10, wherein at least one end cap component is made of a metal, thermoset, or thermoplastic.

13. The method of claim 10, wherein at least one end cap component comprises one or more connection terminals.

14. A system for multi resin pultrusion, the system comprising:
a first material disposed on a first spool and configured to be pulled from one end;
a first resin receptacle disposed downline from the first material comprising at least an opening and configured to allow the first material to be pulled at least partially through a first resin disposed therein;
a second material disposed on a second spool and configured to be pulled from one end parallel to and in the same direction as the first material;
a second resin receptacle disposed downline from the second material comprising at least an opening and configured to allow the second material to be pulled at least partially through a second resin disposed therein;
an isolator material disposed on a third spool disposed in between the first material and the second material and configured to be pulled parallel to and in the same direction as the first material and the second material,
the isolator disposed between the first and second material; and
at least one die disposed downline from the first material, the second material, and the isolator material configured to impart a cross sectional shape to the first material, the second material and the isolator material therebetween as they are pulled through the die.

15. The system of claim 14, wherein:
the at lest one die comprises a first cavity and a second cavity separated therebetween by a wall;
the first resin is configured to be injected into the first cavity and pulled through the die as a solid;
the second resin is configured to be injected into the second cavity and pulled through the die as a solid; and
wherein the solid formed by the first resin and the solid formed by the second resin are pulled through the die to form a hybrid resin pultrusion, wherein the hybrid resin pultrusion is the coupled first resin and second resin.

16. The system of claim 14, wherein:
a first die is disposed downline from the first material configured to impart a cross sectional shape to the first material; and
a second die disposed downline from the second resin configured to impart a cross sectional shape to the first and the second material.

17. The system of claim 16, wherein:
the first die comprises a first mandrel configured to force the first resin into a first area and a blocking mandrel configured to prevent the first resin to enter a second area; and
the second die comprises the blocking mandrel which has tapered down to a smaller cross sectional area, therefore allowing the second resin to enter a second area and the first resin has since cured therefore preventing the second resin to enter the first area.

18. The system of claim 16, wherein the first die and the second die are configured to impart a common cross sectional shape.

19. The system of claim 16, wherein the first die is configured to impart a first cross section shape and the second die is configured to impart a second cross sectional shape.

20. The system of claim 16, wherein the first and second material exit the second die to form an integral component.
